(19) United States
(12) Patent Application Publication
(10) Pub. No.: US 2023/0311099 A1
(43) Pub. Date: Oct. 5, 2023

(54) CARBON DIOXIDE REDUCTION CATALYST

(71) Applicant: HONDA MOTOR CO., LTD., Tokyo (JP)

(72) Inventors: Osami YAMAMOTO, Saitama-ken (JP); Chiharu KAIDA, Saitama-ken (JP); Hajime UTO, Saitama-ken (JP); Noritatsu TSUBAKI, Toyama-ken (JP)

(21) Appl. No.: 18/189,297

(22) Filed: Mar. 24, 2023

(30) Foreign Application Priority Data
Mar. 29, 2022 (JP) 2022-052774

(51) Int. Cl. B01J 23/825; B01J 21/06; B01J 37/03

(52) U.S. Cl. CPC B01J 23/825; B01J 21/066; B01J 37/03; B01J 2231/625; B01J 2523/12

(57) ABSTRACT

A carbon dioxide reduction catalyst for hydrogenating carbon dioxide to reduce carbon dioxide to produce a hydrocarbon, containing Fe and Zr as catalytic metals. It is preferable that Ga and Na are further contained as the catalytic metals, and the content of Zr in the catalytic metals is more than 0% by mass and 15% by mass or less.

### BACKGROUND

### Technical Field

The present invention relates to a carbon dioxide reduction catalyst.

### Related Art

In order to reduce adverse effects on the global environment, exhaust gas regulations for automobiles have further progressed. In particular, carbon dioxide contained in exhaust gas of an internal combustion engine is said to be a cause of global warming, and reduction of carbon dioxide emission is required.

Conventionally, a technique for producing a fuel by hydrogenating carbon dioxide has been known. For example, as a catalyst for synthesizing methanol from a mixed gas of carbon dioxide and hydrogen, a catalyst composed of Cu, Zn and alumina has been proposed (see JP S45-16682 B).

By the way, it is required that a hydrocarbon having, for example, 5 or more carbon atoms, which can be used as a liquid fuel, can be produced as a fuel obtained by hydrogenating carbon dioxide. As such a technique, a method for preparing a highly branched C5 or higher product by using potassium as a co-catalyst with respect to an Fe catalyst in an FT (Fischer-Tropsch) synthesis reaction has been proposed (see JP 2005-537340 A).

### SUMMARY

It is considered that potassium used as a co-catalyst in the technique disclosed in JP 2005-537340 A has a function of capturing carbon dioxide in the FT synthesis reaction. However, it is considered that potassium as a co-catalyst does not directly contribute to an increase in the number of carbon atoms in the produced hydrocarbon. For this reason, it has been impossible to produce a hydrocarbon having, for example, 5 or more carbon atoms at a high yield at a high flow rate of, for example, an exhaust gas of an internal combustion engine.

In response to such a problem, the present inventors have found that by adding gallium as a co-catalyst to a sodium iron catalyst, iron is micronized to increase the reaction site of the iron catalyst, so that the reaction time of the FT synthesis reaction, that is, the time for growth of a carbon chain of a produced hydrocarbon can be secured, and as a result, it has been reported that the yield of a hydrocarbon having 5 or more carbon atoms can be improved even at a high flow rate (Japanese Patent Application No. JP 2021-117832). However, in order to convert carbon dioxide into a liquid fuel with less energy, it is desired to further improve the ability to produce a hydrocarbon having 5 or more carbon atoms in the carbon dioxide reduction catalyst.

The present invention has been made in view of the above problems, and an object thereof is to provide a carbon dioxide reduction catalyst capable of producing a hydrocarbon having 5 or more carbon atoms at a higher yield even at a high flow rate.

As a result of intensive studies to solve the above problems, the present inventors have found that the addition of Zr (zirconium) in an Fe (iron) catalyst can promote carbide formation of iron particles, growth of carbon chain is promoted thereby, and a hydrocarbon having 5 or more carbon atoms can be produced at a high yield, thereby completing the present invention. The present invention provides the following specific aspects and the like.

[1] A carbon dioxide reduction catalyst for hydrogenating carbon dioxide to reduce carbon dioxide to produce a hydrocarbon, containing Fe and Zr as catalytic metals.

[2] The carbon dioxide reduction catalyst according to [1], further containing Ga as the catalytic metal.

[3] The carbon dioxide reduction catalyst according to [1], further containing Na as the catalytic metal.

[4] The carbon dioxide reduction catalyst according to [1], in which the content of the Zr in the catalytic metals is more than 0% by mass and 15% by mass or less.

[5] The carbon dioxide reduction catalyst according to [1], in which the catalytic metal includes an Fe—Zr composite oxide formed by the Fe and the Zr.

[6] A method for producing the carbon dioxide reduction catalyst according to [1], the method including a coprecipitation step of extracting a precipitate from an aqueous solution obtained by dissolving at least predetermined amounts of a nitrate of the Fe and a nitrate of the Zr in distilled water by a coprecipitation method.

[7] The method for producing the carbon dioxide reduction catalyst according to [6], further including, next to the coprecipitation step, an impregnation step of adding dropwise an aqueous solution containing Na to the precipitate, drying the aqueous solution for a predetermined period, and firing the resulting powder at a predetermined temperature.

[8] The method for producing the carbon dioxide reduction catalyst according to [6], in which in the coprecipitation step, a precipitate is extracted by a coprecipitation method from an aqueous solution in which at least predetermined amounts of the nitrate of the Fe, the nitrate of the Zr, and a nitrate of Ga are dissolved in distilled water.

According to the present invention, it is possible to provide a carbon dioxide reduction catalyst capable of producing a hydrocarbon having 5 or more carbon atoms at a higher yield even at a high flow rate.

### BRIEF DESCRIPTION OF DRAWINGS

FIG. 1 is a graph showing CO₂ conversion rates according to Example, Comparative Examples, and Reference Example;

FIG. 2 is a graph showing C-containing component selectivities according to Example, Comparative Examples, and Reference Example;

FIG. 3 is a graph showing C₅₊ production rates according to Example, Comparative Examples, and Reference Example;

FIG. 4 is a graph showing a relationship between the CO₂ conversion rate and the Zr content;

FIG. 5 is a graph showing a relationship between the C₅₊ selectivity and the Zr content;

FIG. 6 is a graph showing a relationship between the C₅₊ production rate and the Zr content; and

FIG. 7 is a graph showing a result of measuring the state of Fe atoms according to Example and Reference Example.

### DETAILED DESCRIPTION

Hereinafter, an embodiment according to the present invention will be described. The carbon dioxide reduction catalyst according to the present embodiment is a catalyst capable of hydrogenating carbon dioxide to reduce carbon dioxide and produce a hydrocarbon. In particular, the carbon dioxide reduction catalyst according to the present embodiment has a high production ratio and production rate of hydrocarbons having 5 or more carbon atoms as compared to those of conventional catalysts. A supply source of carbon dioxide is not particularly limited, but the carbon dioxide reduction catalyst according to the present embodiment can preferably produce a hydrocarbon having 5 or more carbon atoms even for a supply source to which carbon dioxide is supplied at a high flow rate, such as exhaust gas of an internal combustion engine.

### <Carbon Dioxide Reduction Catalyst>

The carbon dioxide reduction catalyst (hereinafter, it may be simply referred to as a “catalyst”.) according to the present embodiment contains Fe (iron) and Zr (zirconium) as catalytic metals. In addition, Ga (gallium) is preferably further contained. Further, Na (sodium) is preferably further contained. The carbon dioxide reduction reaction using the catalyst according to the present embodiment is a reaction in which a mixed gas of H₂ (hydrogen) and CO₂ (carbon dioxide) is used as a raw material, and a reverse shift reaction in which CO₂ is reduced to CO (carbon monoxide) and an FT synthesis reaction in which CO is converted to a hydrocarbon are performed in one step to produce a hydrocarbon. The catalyst according to the present embodiment contributes to both the reverse shift reaction and the FT synthesis reaction. The carbon dioxide reduction reaction using the catalyst according to the present embodiment can highly efficiently produce a hydrocarbon having 5 or more carbon atoms even at a high flow rate of, for example, space velocity (SV)=about 50,000 h⁻¹ as compared to the conventional FT synthesis reaction.

Fe contained in the catalytic metal according to the present embodiment may be a compound such as an oxide, a carbonic acid compound, a nitric acid compound, or a sulfuric acid compound, and is preferably an oxide. Two or more of these compounds may be contained. In addition, Fe is more preferably contained in the catalytic metal as an Fe—Zr composite oxide formed of Fe and Zr. By using the catalytic metal containing the Fe—Zr composite oxide, the Fe particles can be further carbided in the FT synthesis reaction, thereby promoting CH₂ growth reaction in the catalyst and promoting growth of carbon chain. Therefore, the yield of hydrocarbons having 5 or more carbon atoms can be improved even at a high flow rate.

The content of Fe in the catalytic metal according to the present embodiment is preferably within a range of 55 to 90% by mass, and more preferably 60 to 75% by mass in terms of metal atoms.

Like Fe, Zr contained in the catalytic metal according to the present embodiment may be a compound such as an oxide, a carbonic acid compound, a nitric acid compound, or a sulfuric acid compound, and is preferably an oxide. Two or more of these compounds may be contained. Zr is more preferably contained in the catalytic metal as an Fe—Zr composite oxide formed by Fe and Zr.

The content of Zr in the catalytic metal according to the present embodiment is preferably more than 0% by mass and 15% by mass or less, and more preferably 5 to 10% by mass in terms of metal atoms. By setting the content of Zr to 15% by mass or less, it is possible to avoid adverse effects caused by covering the reaction site of Fe with Zr, and it is possible to prevent a decrease in catalytic activity.

The catalytic metal according to the present embodiment preferably further contains Ga. As with Fe and Zr, Ga may be a compound such as an oxide, a carbonic acid compound, a nitric acid compound, or a sulfuric acid compound, and is preferably an oxide. Two or more of these compounds may be contained. Ga is more preferably contained in the catalytic metal as an Fe—Ga—Zr composite oxide formed of Fe, Zr, and Ga. Since the Fe—Ga—Zr composite oxide is micronized as compared to a compound such as iron oxide, the reaction site of the Fe catalyst increases, so that the reaction time of the FT synthesis reaction, that is, the time for growing the carbon chain of the produced hydrocarbon can be secured. Therefore, the yield of hydrocarbons having 5 or more carbon atoms can be improved even at a high flow rate.

The content of Ga in the catalytic metal according to the present embodiment is preferably 10 to 30% by mass, and more preferably 20 to 30% by mass in terms of metal atoms. By setting the content of Ga to 10% by mass or more, the catalytic metal can be sufficiently micronized. In addition, by setting the content of Ga to 30% by mass or less, it is possible to avoid adverse effects caused by covering the reaction site of Fe with Ga, and it is possible to prevent a decrease in catalytic activity.

The catalytic metal according to the present embodiment preferably further contains Na. Na functions as a co-catalyst in a catalytic metal containing Fe and Zr, and can promote a reverse shift reaction in which CO is produced from H₂ and CO₂ by capturing CO₂ as Na₂CO₃, and the CO₂ conversion rate can be improved. Na is preferably present on the surface of the Fe—Zr composite oxide or the Fe—Ga—Zr composite oxide in the form of an oxide or the like, separately from the Fe—Zr composite oxide or the Fe—Ga—Zr composite oxide. The catalytic metal may contain an alkali metal such as Li, K, Rb, or Cs instead of Na or together with Na.

The content of Na in the catalytic metal according to the present embodiment is preferably 0.5 to 1.5% by mass, and more preferably 1.0% by mass. By setting the content of Na to 0.5% by mass or more, the production efficiency of a hydrocarbon having 5 or more carbon atoms can be sufficiently improved. In addition, by setting the content of Na to 1.5% by mass or less, it is possible to avoid adverse effects caused by covering the reaction site of Fe with Na, and it is possible to prevent a decrease in catalytic activity.

The carbon dioxide reduction catalyst according to the present embodiment may be, for example, a powder of a catalytic metal or a pellet-shaped molded body formed by pressure-molding the catalytic metal. In addition, a catalytic metal may be supported on a known catalyst carrier such as silica. In addition to the above, the carbon dioxide reduction catalyst according to the present embodiment may contain inevitable impurities mixed in the catalyst production process and the like, but preferably contains no impurities as much as possible.

### <Method for Producing Carbon Dioxide Reduction Catalyst>

The method for producing a carbon dioxide reduction catalyst according to the present embodiment includes a coprecipitation step. Also, the coprecipitation step is preferably followed by an impregnation step.

### (Coprecipitation Step)

The coprecipitation step in the present embodiment is a step of extracting a precipitate as a catalyst precursor from an aqueous solution in which predetermined amounts of a nitrate of Fe and a nitrate of Zr are dissolved in distilled water by a coprecipitation method. An Fe—Zr composite oxide is formed by the coprecipitation step. In the coprecipitation step, a Na₂CO₃ aqueous solution is added dropwise to the aqueous solution containing Fe and Zr to obtain a precipitation solution. Thereafter, the precipitate is separated from the precipitation solution by filtration, washing or the like, and dried to obtain a precipitate (Fe—Zr composite oxide) as a catalyst precursor.

The coprecipitation step in another aspect is a step of extracting a precipitate as a catalyst precursor from an aqueous solution in which predetermined amounts of a nitrate of Fe, a nitrate of Zr, and a nitrate of Ga are dissolved in distilled water by a coprecipitation method. An Fe—Ga—Zr composite oxide is formed by the coprecipitation step. In the coprecipitation step, a Na₂CO₃ aqueous solution is added dropwise to the aqueous solution containing Fe, Zr, and Ga to obtain a precipitation solution. Thereafter, the precipitate is separated from the precipitation solution by filtration, washing or the like, and dried to obtain a precipitate (Fe—Ga—Zr composite oxide) as a catalyst precursor.

### (Impregnation Step)

The impregnation step in the present embodiment is a step in which an aqueous solution containing Na is added dropwise to the precipitate obtained by the coprecipitation step and dried for a predetermined time, and the obtained powder is fired at a predetermined temperature. By this impregnation step, the Na compound can be unevenly distributed in the vicinity of the surface of the Fe—Zr composite oxide. Examples of the aqueous solution containing Na include a NaNO₃ aqueous solution. The NaNO₃ aqueous solution can be added dropwise under ultrasonic excitation. As a result, the Na compound can be homogeneously and unevenly distributed in the vicinity of the surface of the Fe—Zr composite oxide. The firing temperature can be, for example, 550° C., and the firing time can be, for example, 4 hours.

The impregnation step in another aspect is a step in which an aqueous solution containing Na is added dropwise to the precipitate obtained by the coprecipitation step and dried for a predetermined time, and the obtained powder is fired at a predetermined temperature. By this impregnation step, the Na compound can be unevenly distributed in the vicinity of the surface of the Fe—Ga—Zr composite oxide. Examples of the aqueous solution containing Na include a NaNO₃ aqueous solution. The NaNO₃ aqueous solution can be added dropwise under ultrasonic excitation. As a result, the Na compound can be homogeneously and unevenly distributed in the vicinity of the surface of the Fe—Ga—Zr composite oxide. The firing temperature can be, for example, 550° C., and the firing time can be, for example, 4 hours.

The present invention is not limited to the above embodiments, and modifications and improvements within the scope of achieving the object of the present invention are included in the present invention.

### EXAMPLES

Next, examples of the present invention will be described, but the present invention is not limited to these examples.

### Example 1

A nitrate of Fe (Fe(NO₃)₃·9H₂O ) as catalytic metal 1, a nitrate of Zr (ZrO(NO₃)₂·2H₂O) as catalytic metal 2, and a nitrate of Ga (Ga(NO₃)₃·6H₂O) as catalytic metal 3 shown in Table 1 were weighed so that the mass ratio of Fe:Zr:Ga in terms of metal atoms was 6:1:3, and dissolved in distilled water. Then, while the aqueous solution was stirred, a 1.0 M Na₂CO₃ aqueous solution was added dropwise at 2 ml/min and fixed to pH 8.5, thereby obtaining a precipitation solution containing Fe, Zr, and Ga as precipitates. Next, the precipitation solution was aged at room temperature for 24 hours, and then filtration and washing were repeated to separate the precipitate. The separated precipitate was dried at 60° C. for 12 hours to obtain an Fe—Ga—Zr catalyst precursor.

A NaNO₃ aqueous solution was added dropwise to the Fe—Ga—Zr catalyst precursor under an ultrasonic excitation of 92 kHz so that the Na content was 1.0% by mass. Subsequently, the resultant was dried under vacuum at 5000 Pa for 1 hour, and further dried at 60° C. under normal pressure for 12 hours to obtain a powder. The obtained powder was calcined at 550° C. for 4 hours to obtain a catalyst according to Example 1.

### Examples 2 to 3, Comparative Examples 1 to 4, Reference Example

Catalysts according to Examples 2 to 3, Comparative Examples 1 to 4, and Reference Example were obtained in the same manner as in Example 1 except that the content of the catalytic metal 1 (Fe), the type and content of the catalytic metal 2, and the content of the catalytic metal 3 (Ga) were changed to those shown in Table 1, respectively. In Comparative Example 1, the catalytic metal 2 and the catalytic metal 3 were not used, and only a nitrate of Fe was used. In the reference example, the catalytic metal 2 was not used, and only a nitrate of Fe and a nitrate of Ga were used. Although parts by mass of the catalytic metal 1, the catalytic metal 2, and the catalytic metal 3 are shown in Table 1, the catalytic metals according to each of Examples, Comparative Examples, and Reference Example contain 1.0% by mass of Na in addition to the catalytic metals 1 to 3 shown in Table 1.

TABLE 1

| | Catalytic | | | Catalytic |
|---|---|---|---|---|
| | metal 1 (Fe) | Catalytic metal 2 | | metal 3 (Ga) |
| | Content | | Content | Content |
| | (parts by mass) | Type | (parts by mass) | (parts by mass) |
| Example 1 | 60 | Zr | 10 | 30 |
| Example 2 | 65 | Zr | 5 | 30 |
| Example 3 | 55 | Zr | 15 | 30 |
| Reference | 70 | — | — | 30 |
| Example | | | | |
| Comparative | 100 | — | — | — |
| Example 1 | | | | |
| Comparative | 60 | In | 10 | 30 |
| Example 2 | | | | |
| Comparative | 60 | Sn | 10 | 30 |
| Example 3 | | | | |
| Comparative | 60 | Si | 10 | 30 |
| Example 4 | | | | |

### Evaluation

Carbon dioxide reduction reactions were performed for the carbon dioxide reduction catalysts of Examples 1 to 3, Comparative Examples 1 to 4, and Reference Example by the following methods. The apparatus used a fixed-bed flow type reactor, and the reaction gas was CO₂ 2.8 NL/h and H₂ 8.4 NL/h (CO₂/H₂=⅓). As the carbon dioxide reduction catalyst according to each of the examples, comparative examples, and reference example, 0.25 g of a 0.4 to 0.8 mm square pellet was used. The pellet was filled in a reaction tube (inner diameter: 6 mm) at a length of 5 cm and used. W/F (catalyst weight/gas flow rate) was 0.5 g h/mol, and SV (space velocity) was 50,000 h⁻¹. The reaction conditions were a temperature of 380° C., a pressure of 3 MPa, and a reaction time of 4 hours. The gas components after the catalytic reaction were qualitatively and quantitatively analyzed by online gas chromatography (Shimadzu, GC-2014AT, detector: thermal conductivity detector (TCD)) and flame ionization detector (FID) (Shimadzu, GC-2014AF). The liquid component after the catalytic reaction was also qualitatively and quantitatively analyzed by offline gas chromatography (Shimadzu, GC-2014AF, detector: flame ionization detector (FID)).

### (CO₂ Conversion Rate)

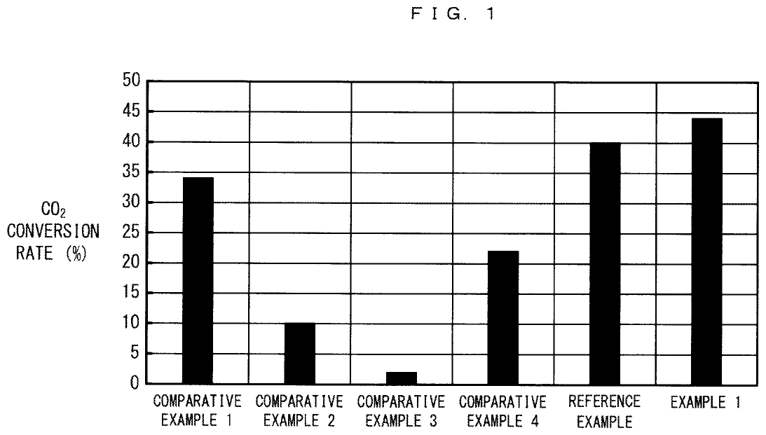

The conversion rate of CO₂ by the carbon dioxide reduction reaction was determined by the following formula (1). The results are shown in FIG. 1.

CO₂ Conversion rate (%)=((CO₂ Concentration before reaction)−(CO₂ Concentration after reaction))/(CO₂ Concentration before reaction)×100 (1)

### (C-Containing Component Selectivity)

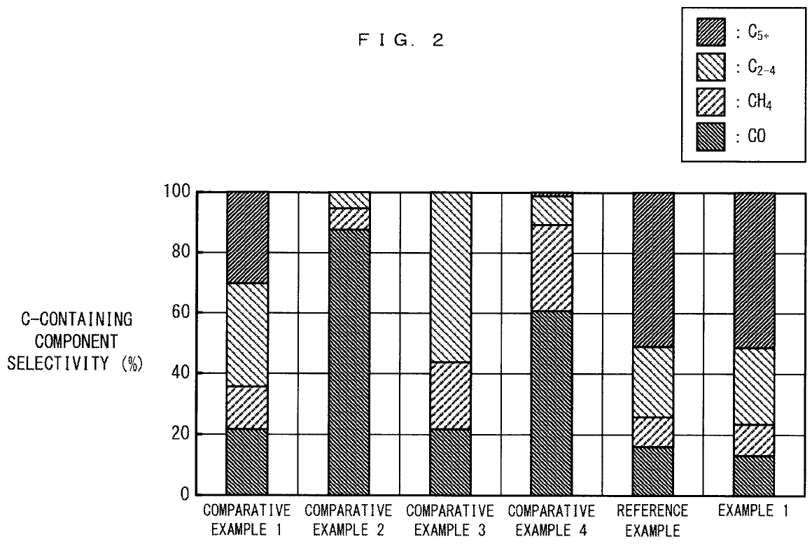

The selectivity of each C-containing component (CO, CH₄, C₂₋₄, C₅₊) produced by the carbon dioxide reduction reaction was determined by the following formula (2). C₂₋₄ represents a hydrocarbon having 2 to 4 carbon atoms, and C₅₊ represents a hydrocarbon having 5 or more carbon atoms. The results are shown in FIG. 2.

Each C-containing component selectivity (%)=(Each C-containing component concentration)/((CO₂ Concentration before reaction)−(CO₂ Concentration after reaction))×100 (2)

### (C₅₊ Production Rate)

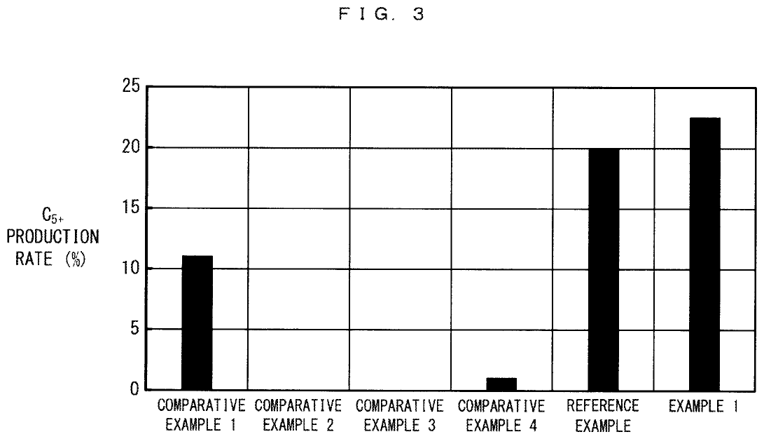

The production rate of C₅₊ (hydrocarbon having 5 or more carbon atoms) produced by the carbon dioxide reduction reaction was determined by the following formula (3). The results are shown in FIG. 3.

C₅₊ Production rate (%)=CO₂ Conversion rate×C₅₊ Selectivity/100 (3)

### (Relationship Between Zr Content and CO₂ Conversion Rate)

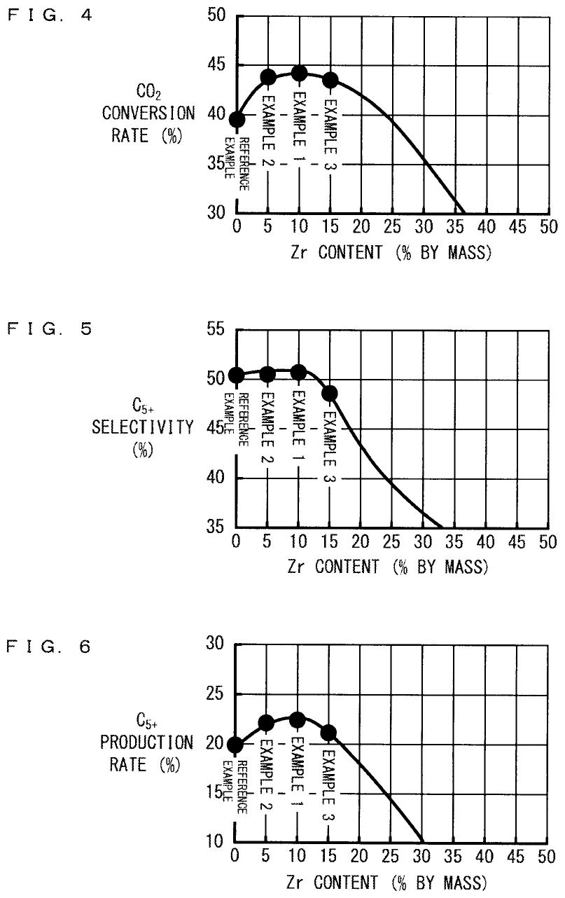

Next, a relationship between the Zr content and the CO₂ conversion rate in the carbon dioxide reduction reaction using the catalysts of Examples 1 to 3 in which the mass ratio of Fe and Zr in the catalytic metal was changed as shown in Table 1 and Reference Example not containing Zr was examined. The results are shown in FIG. 4. In FIG. 4, the vertical axis represents the CO₂ conversion rate (%) obtained by the above formula (1), and the horizontal axis represents the Zr content (% by mass). Each catalyst contains 1.0% by mass of Na, and as the Zr content, a mass ratio of Zr to the total of Fe, Ga, and Zr in the catalytic metal can be used as an approximate value (the same applies hereinafter).

### (Relationship Between Zr Content and C₅₊ Selectivity)

Next, a relationship between the Zr content and the C₅₊ selectivity in the carbon dioxide reduction reaction using the catalysts of Examples 1 to 3 and Reference Example was examined in the same manner as in FIG. 4. The results are shown in FIG. 5. In FIG. 5, the vertical axis represents the C₅₊ selectivity (%) obtained by the above formula (2), and the horizontal axis represents the Zr content (% by mass).

### (Relationship Between Zr Content and C₅₊ Production Rate)

Next, a relationship between the Zr content and the C₅₊ production rate in the carbon dioxide reduction reaction using the catalysts of Examples 1 to 3 and Reference Example was examined in the same manner as in FIG. 4. The results are shown in FIG. 6. In FIG. 6, the vertical axis represents the C₅₊ production rate (%) obtained by the above formula (3), and the horizontal axis represents the Zr content (% by mass).

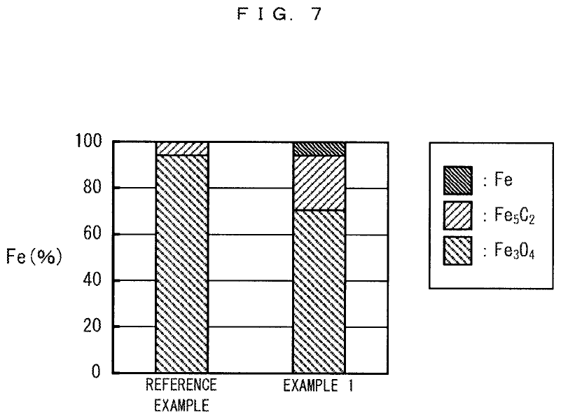

Next, the state of Fe atoms in the catalyst after the reaction was examined in the carbon dioxide reduction reaction using the catalyst of Example 1 containing 10% by mass of Zr in terms of metal atoms and the catalyst of Reference Example not containing Zr. The state of Fe atoms in the catalyst was determined by performing measurement by Moessbauer spectroscopy on a flaked catalyst after performance evaluation, and determining the contribution of Fe₃O₄, Fe₅C₂, and Fe to the obtained spectrum by fitting. The results are shown in FIG. 7. Here, the details of the measurement by Moessbauer spectroscopy are as follows.

Measurement conditions: constant acceleration mode, room temperature, under normal pressure

Source: ⁵⁷Co/Rh matrix, 1.85 [GBq]

### Discussion

From FIGS. 1 to 3, it is apparent that the catalyst of Example 1 has a high CO₂ conversion rate, a high selectivity to hydrocarbons having 5 or more carbon atoms, and a high production rate of hydrocarbons having 5 or more carbon atoms as compared to those of the catalysts of Comparative Example 1 using only Fe as the conventional catalytic metal, Reference Example using only Fe and Ga as catalytic metals, and Comparative Examples 2 to 4 using other metal elements in place of Zr as the catalytic metal 2, and is excellent in catalytic activity. Incidentally, the catalyst of Reference Example also showed high values in all of the CO₂ conversion rate, the C₅₊ selectivity, and the C₅₊ production rate as compared to Comparative Examples 1 to 4, but Example 1 showed an even higher value as compared to that of Reference Example, and it is considered that the addition of Zr further improved the activity of the catalyst.

In addition, from FIGS. 4 to 6, it is apparent that the content of Zr as a catalytic metal is preferably in a range of more than 0% by mass and 15% by mass or less, and more preferably in a range of 5 to 10% by mass. When the amount of Zr added is increased, the catalytic activity for producing C₅₊ is improved, and the activity is the highest when the Zr content is 10% by mass. On the other hand, when the Zr content exceeds 15% by mass, it is considered that the catalytic activity is reduced as a result of covering the reaction site of Fe with Zr.

From FIG. 7, in Example 1 in which Zr was added in an amount of 10% by mass in terms of metal atoms, more Fe₅C₂ components as an intermediate in the FT synthesis reaction were detected as compared to Reference Example to which Zr was not added. When considered in conjunction with the results of FIGS. 4 to 6, it is considered that the addition of Zr to the catalytic metal promoted the CH₂ growth reaction in the catalyst, and as a result, the catalytic activity such as the C₅₊ production rate was improved. In addition, the reason why the CH₂ growth reaction in the catalyst is promoted by the addition of Zr is considered to be resulted from the fact that electrons are excessive in 3d orbital of Fe due to electron donation from 4d orbital of Zr to the 3d orbital of Fe, and the excessive electrons flow into the bonding orbital of reaction gas CO adsorbed to Fe, thereby promoting decomposition of CO.

What is claimed is:

1. A carbon dioxide reduction catalyst for hydrogenating carbon dioxide to reduce carbon dioxide to produce a hydrocarbon, comprising:
Fe and Zr as catalytic metals.

2. The carbon dioxide reduction catalyst according to claim 1, further comprising Ga as the catalytic metal.

3. The carbon dioxide reduction catalyst according to claim 1, further comprising Na as the catalytic metal.

4. The carbon dioxide reduction catalyst according to claim 1, wherein the content of the Zr in the catalytic metals is more than 0% by mass and 15% by mass or less.

5. The carbon dioxide reduction catalyst according to claim 1, wherein the catalytic metal includes an Fe—Zr composite oxide formed by the Fe and the Zr.

6. A method for producing the carbon dioxide reduction catalyst according to claim 1, the method comprising:
a coprecipitation step of extracting a precipitate from an aqueous solution obtained by dissolving at least predetermined amounts of a nitrate of the Fe and a nitrate of the Zr in distilled water by a coprecipitation method.

7. The method for producing the carbon dioxide reduction catalyst according to claim 6, further comprising, next to the coprecipitation step, an impregnation step of adding dropwise an aqueous solution containing Na to the precipitate, drying the aqueous solution for a predetermined period, and firing the resulting powder at a predetermined temperature.

8. The method for producing the carbon dioxide reduction catalyst according to claim 6, wherein in the coprecipitation step, a precipitate is extracted by a coprecipitation method from an aqueous solution in which at least predetermined amounts of the nitrate of the Fe, the nitrate of the Zr, and a nitrate of Ga are dissolved in distilled water.
